(19) United States
(12) Patent Application Publication
(10) Pub. No.: US 2026/0265020 A1
(43) Pub. Date: Sep. 10, 2026

(54) ELECTRONIC SAFETY ACTUATOR SYSTEM, ELEVATOR CAR AND COUNTERWEIGHT

(71) Applicant: Otis Elevator Company, Farmington, CT (US)

(72) Inventor: Juan Antonio Illan, Las Rozas (ES)

(21) Appl. No.: 19/406,206

(22) Filed: Dec. 2, 2025

(30) Foreign Application Priority Data
Mar. 10, 2025 (EP) 25382218.3

(51) Int. Cl. B66B 5/22; B66B 5/06

(52) U.S. Cl. CPC B66B 5/22; B66B 5/06

(57) ABSTRACT

An electronic safety actuator system for an elevator car or a counterweight including: a first electronic safety actuator including a first electromagnetic element configured to actuate a first safety brake depending on whether it is supplied with electric power or not, and a first actuation detection switch configured to switch upon actuation of the first safety brake, and a second electronic safety actuator including a second electromagnetic element configured to actuate a second safety brake depending on whether it is supplied with electric power or not, and a second actuation detection switch configured to switch upon actuation of the second safety brake. The first actuation detection switch is linked to the second electromagnetic element to control supply of electric power when switching, and the second actuation detection switch is linked to the first electromagnetic element to control supply of electric power when switching.

### FOREIGN PRIORITY

This application claims priority to European Patent Application No. 25382218.3, filed Mar. 10, 2025, and all the benefits accruing therefrom under 35 U.S.C. § 119, the contents of which in its entirety are herein incorporated by reference.

### TECHNICAL FIELD OF INVENTION

The present disclosure relates to an electronic safety actuator system for an elevator car or a counterweight, and an elevator car or a counterweight comprising such an electronic safety actuator system.

### BACKGROUND OF THE INVENTION

It is known for elevator cars and counterweights for elevators cars to include safety brakes. The function of the safety brakes is to be triggered in the event of an emergency, such as an elevator car over-speed (i.e. the elevator car travel speed exceeding a particular threshold). Once triggered, the safety brakes engage with guide rails in order to brake the motion of the elevator car or the counterweight. In the following, the application of safety brakes is representatively described for an elevator car.

Traditional safety brakes (often referred to simply as safeties) are located either at the top of the elevator car or at the bottom of the elevator car. Normally, one is provided on either side of the elevator car. The safeties are usually mechanically synchronized by a linkage bar or a similar mechanism that extends across the elevator car structure from one side to the other. The linkage bar is connected to a governor rope, such that over-speed of the elevator car will cause relative movement of the governor rope and the linkage bar, thereby triggering the safeties to be engaged. Hence, both safeties are actuated via the linkage bar simultaneously. Consequently, if one of the safety brakes accidentally trips, the other safety brake is also tripped.

Further, it is known to use electronic safety actuators instead of mechanical governors. Electronic safety actuators will be understood to be actuators which trigger actuation of a safety brake based on receipt of an electronic signal, i.e. in contrast to mechanical governors, which are triggered to apply a safety brake by a mechanical action, such as motion caused by a governor rope. However, in electronic safety actuators no mechanical linkage between the safety brakes is provided so that an accidental trip of one safety brakes does not automatically trigger the other safety brake. Hence, the elevator car could derail from guide rails guiding the elevator car within a hoistway.

In this respect, it is an object of the present disclosure to provide an improved technique for synchronization of electronic safety actuators. In particular, the synchronization should be made without signal processing, which might cause a variation of timing of actuation of the safety brakes.

An electronic safety actuator system according to the present disclosure is used for an elevator car or a counterweight of an elevator car and comprises a first electronic safety actuator comprising a first electromagnetic element configured to actuate a first safety brake depending on whether it is supplied with electric power or not, and a first actuation detection switch configured to switch upon actuation of the first safety brake. The electronic actuator system further comprises a second electronic safety actuator comprising a second electromagnetic element configured to actuate a second safety brake depending on whether it is supplied with electric energy or not, and a second actuation detection switch configured to switch upon actuation of the second safety brake.

The first actuation detection switch is linked to the second electromagnetic element to control a supply of electric power when switching. The second actuation detection switch is linked to the first electromagnetic element to control a supply of electric power when switching.

Consequently, in case of an accidental trip of one of the safety brakes the associated actuation detection switch switches and controls supply of electric power to the electromagnetic element of the other one of the safety brakes. Hence, an operation of the other one of the safety brakes is synchronized with the accidentally actuated safety brake.

### SUMMARY OF THE INVENTION

According to an aspect the first electromagnetic element and the second electromagnetic element can be connected to a common power supply via a common power supply circuit. Hence, only one power supply is required for supplying electric power to the electromagnetic elements.

According to a further aspect the first actuation detection switch and the second actuation detection switch can each be linked to the common power supply circuit. In this way, the electric power supplied from the power supply via the common power supply circuit is controllable by switching at least one of the first actuation detection switch and the second actuation detection switch.

According to an additional aspect the first actuation detection switch and the second actuation detection switch can be connected in the common power supply circuit. In this way, the switching operation of one of the actuation detection switches can control a supply of electric power to the electromagnetic elements. Hence, the actuation of the safety brakes can be easily synchronized.

According to a further aspect a resetting contactor can be connected between the first electromagnetic element and the second electromagnetic element via a resetting line and in parallel to the power supply in order to control supply of electric power to the first electromagnetic element and the second electromagnetic element independent of a switching state of the first actuation detection switch and the second actuation detection switch. Hence, by a respective operation of the resetting contactor the electromagnetic elements can be reset.

According to an alternative aspect the first actuation detection switch and the second actuation detection switch can be inductively coupled to the common power supply circuit. Therefore, the supply of electric power to the electromagnetic elements can be controlled without the need to integrate the actuation detection switches into the power supply circuit.

According to an aspect the first actuation detection switch and the second actuation detection switch can be connected to an actuation detection switch circuit separate from the common power supply circuit. The electronic safety actuator system can then further comprise an inductive coupling unit for inductively coupling the actuation detection switch circuit and the common power supply circuit. In this way, it is not necessary to inductively couple each actuation detection switch separately to the power supply circuit.

According to a further aspect the inductive coupling unit can comprise an inductive coupling coil arranged in the actuation detection switch circuit, and an inductive coupling switch arranged in the common power supply circuit and operable in accordance with an operation state of the inductive coupling coil. Hence, the inductive coupling switch can be controlled by controlling a supply of electric power to the inductive coupling coil.

According to aspect an auxiliary power supply can be arranged in the actuation detection switch circuit. The auxiliary power supply can then be used to control the supply of electric power to the inductive coupling coil.

According to an additional aspect a resetting contactor can be connected in parallel to the inductive coupling unit and the auxiliary power supply via a resetting line in order to control supply of electric power to the inductive coupling unit from the auxiliary power supply. Hence, the resetting contactor can be used to control supply of electric power to the inductive coupling unit, i.e. the inductive coupling coil, to reset the electromagnetic elements.

According to yet another aspect an over-speed contactor can be arranged in the common power supply circuit. In this way, the power supply to the electromagnetic elements can be easily controlled in case over-speed of the elevator car or the counterweight is detected, for example by an electronic over-speed sensor.

According to one aspect the power supply, the auxiliary power supply, the resetting contactor, the over-speed contactor, and the inductive coupling unit can be arranged on a safety actuator board. In this way, these components can be easily installed in or to the elevator car, e.g. in a control panel of the elevator car, or the counterweight.

According to an aspect the first electromagnetic element and the second electromagnetic element can be configured to actuate the first safety brake and the second safety brake, respectively, when electric power is not supplied. Hence, the electromagnetic elements are always energized during a normal operation of the elevator car or the counterweight. Hence, an actuation of the safety brake can be controlled simply by interrupting the power supply to the electromagnetic elements. This approach is also less prone to error since the power supply can be unavailable unnoticed in case of over-speed of the elevator car or the counterweight occurs.

According to another aspect the first actuation detection switch and the second actuation detection switch can each be configured to open upon actuation of the first safety brake and the second safety brake, respectively. This is beneficial in case the electromagnetic elements actuate the safety brakes when electric power is not supplied. The actuation detection switches can then interrupt supply of electric power to the electromagnetic elements when opening, so that the electromagnetic elements coupled to the common power supply circuit are de-energized.

According to yet another aspect the over-speed contactor can be configured to open upon detection of an over-speed of the elevator car or the counterweight. This is beneficial in case the electromagnetic elements are configured to actuate the safety brakes when no power is supplied. The safety brakes can then be easily controlled by opening the over-speed contactor in case over-speed is detected.

According to a further aspect the resetting contactor can be configured to close in order to operate the first electromagnetic element and the second electromagnetic element. This is beneficial in case the safety brakes are operated by de-energizing the electromagnetic element. Further, this configuration is suited for an embodiment, in which the power supply circuit is inductively coupled to the actuation detection switch circuit and the auxiliary power supply is connected in the resetting line.

An elevator car according to the present disclosure comprises the electronic safety actuator system according to any of the above aspects, the first safety brake and the second safety brake. Hence, the operation of the safety brakes can be reliably synchronized so that an accidental trip of one safety brakes also triggers the other safety brake. Hence, derailing of the elevator car can be safely avoided.

A counterweight according to the present disclosure comprises the electronic safety actuator system according to any of the above aspects, the first safety brake and the second safety brake. Hence, the operation of the safety brakes can be reliably synchronized so that an accidental trip of one safety brakes also triggers the other safety brake. Hence, derailing of the counterweight can be safely avoided.

According to one aspect the first safety brake and the second safety brake can be installed on opposite sides of the elevator car.

### BRIEF DESCRIPTION OF THE DRAWINGS

Embodiments of the present disclosure will be described with reference to the drawings. In the drawings:

FIG. 1 schematically shows an elevator system having an elevator car comprising electronic safety actuators and electronic safety brakes;

FIG. 2 schematically shows a cutaway side view of a symmetrical safety brake, which may be used as safety brake;

FIG. 3 schematically shows an electronic safety actuator system according to one embodiment; and

FIG. 4 schematically shows an electronic safety actuator system according to another embodiment.

### DETAILED DESCRIPTION OF THE INVENTION

In the drawings, the same or corresponding elements are denoted by the same reference signs. The description of the embodiments is not intended to limit the scope of the present disclosure in any way.

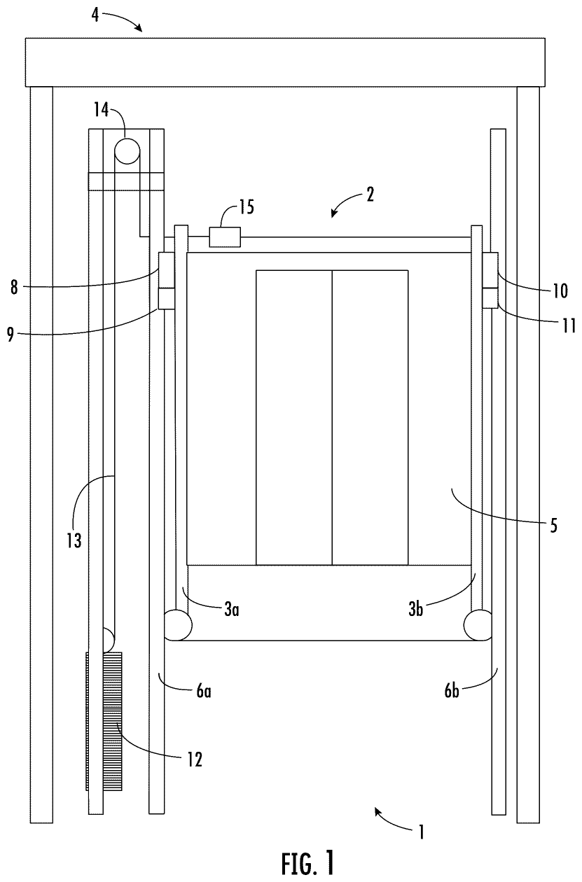

FIG. 1 shows an exemplary elevator system 1 including an elevator car 2, which is arranged to travel within a hoistway 4. The elevator car 2 travels along a first guide rail 6a, which is located on a first side of the hoistway 4, and a second guide rail 6b, which is located on a second, opposite side of the hoistway 4.

The elevator car 2 includes a frame with two uprights 3a, 3b and a cabin 5 mounted to the frame. A first safety brake 8 is positioned on a first side of the elevator car 2 (e.g., on the upright 3a) and a second safety brake 10 is positioned on a second side of the elevator car 2 (e.g., on the upright 3b). Adjacent to the first safety brake 8 there is arranged a corresponding first electronic safety actuator 9 configured to actuate the first safety brake 8. Likewise, a second electronic safety actuator 11 configured to actuate the second safety brake 10 is arranged adjacent to the second safety brake 10. It is to be noted, that the electronic safety actuators 9, 11 and the respective safety brakes 8, 10 are shown as separate units in FIG. 1. However, an electronic safety actuator and a corresponding safety brake can be integrated into a single unit, which can comprise a single housing, for example. In the elevator car 2 shown in FIG. 1, the first safety brake 8 and the second safety brake 10 are located at the same height at a top of the elevator car 2. However, since the safety brakes 8, 10 do not have mechanical linkage they can be arranged at a different height, i.e. not at the top or the bottom of the elevator car 2. Further, the safety brakes 8, 10 can be arranged at different heights on their respective side of the elevator car 2, i.e. one safety brake can be arranged higher than the other one.

The elevator car 2 further includes a first guide element (not shown) located in proximity to the first safety brake 8 and a second guide element (not shown) located in proximity to the second safety brake 10. The first guide element and the second guide element can be guide shoes. The guide elements attach to the elevator car 2, i.e. to the uprights 3a, 3b, and help it to run up and down the guide rails 6a, 6b when it travels within the hoistway 4. The guide elements may slide on the guide rails 6a, 6b or they may have rollers that roll along guide rails 6a, 6b. In addition, there may be provided two guide elements on each side of the elevator car 2, e.g. an upper guide element and a lower guide element.

The elevator car 2 is connected to a counterweight 12 by one or more tension members 13. The tension member 13 is driven by a machine 14 to drive motion of the elevator car 2 and the counterweight 12.

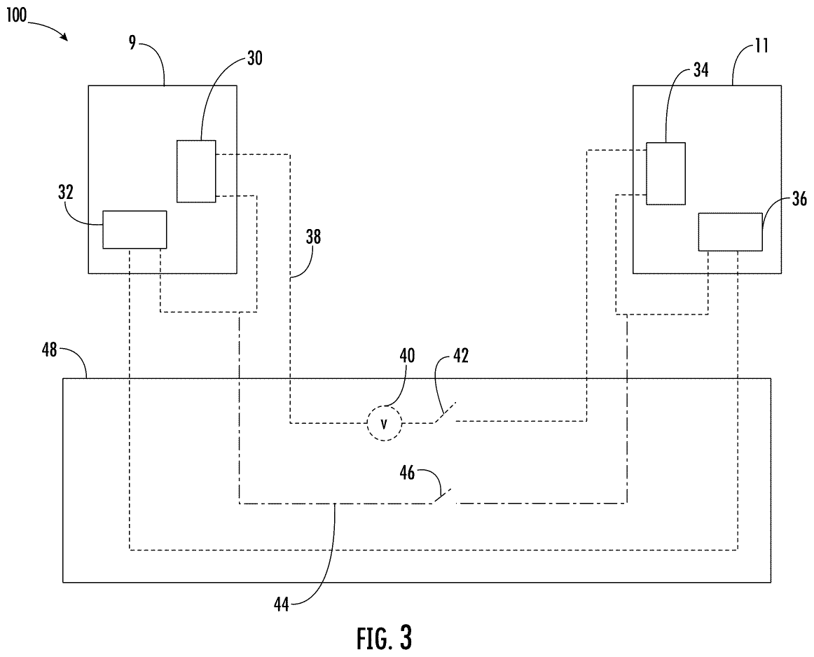

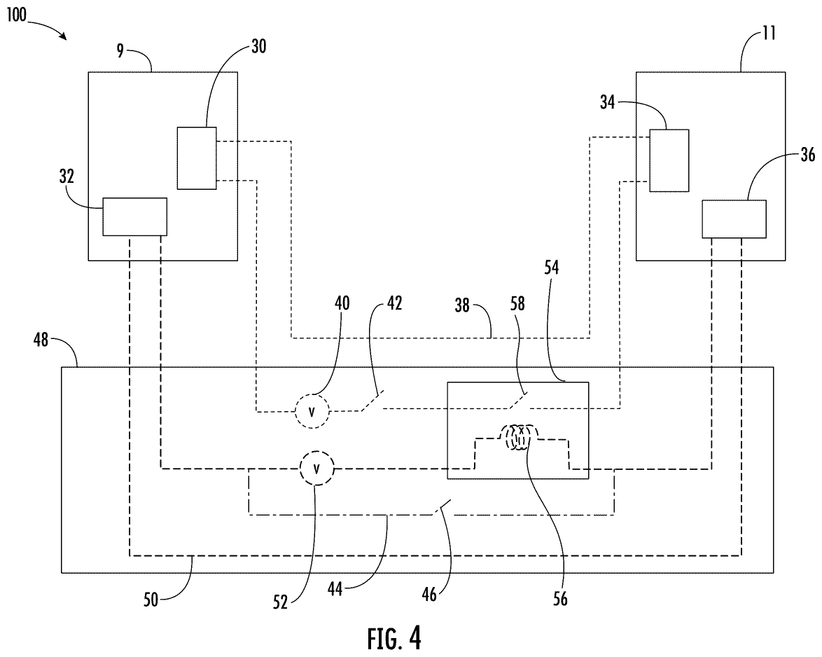

The elevator system 1 includes an electronic over-speed sensor 15 mounted on the elevator car 2 and configured to trigger engagement of each of the safety brakes 8, 10, if it detects an over-speed of the elevator car 2. For example, the electronic over-speed sensor 15 may send an electronic signal to a safety actuator board 48 (see FIGS. 3 and 4), which commands triggering of the safety brakes 8, 10. In one example, the electronic over-speed sensor 15 may be arranged to read signals from the hoistway 4 (e.g. on a stationary element mounted in the hoistway 4, e.g. markings or other detectable areas on a tape or rail in the hoistway 4).

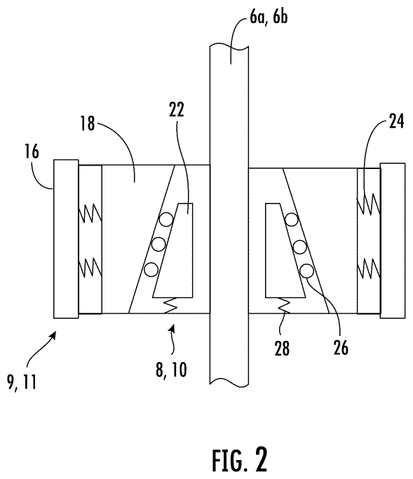

FIG. 2 shows a symmetric safety brake 8, 10, which can be actuated by an electronic safety actuator 9, 11. The safety brake 8, 10 is arranged symmetrically on either side of the guide rail 6a, 6b. The operation of only one side of the safety brake 8, 10 will be described, but it will be understood that this process will occur simultaneously on each side of the safety brake 8, 10. The electronic safety actuator 9, 11 includes an electromagnetic component 16, which engages with a magnetic portion 18 of the safety brake 8, 10. According to one example the electromagnetic component 16, e.g. a coil, and the magnetic portion 18 can form an electromagnetic valve. That is, the safety brake 8, 10 is actuated by using the electromagnetic component 16, e.g. the coil.

The magnetic portion 18 is biased by springs 24 either towards or away from the electromagnetic element 16. When the electromagnetic element 16 energizes or de-energizes (depending on the biasing of the springs) in accordance with supplied electric power, so as to drive the magnetic portion 18 towards the guide rail 6a, 6b, either by magnetic forces acting against the biasing force of the springs 24, or by the biasing force of the springs 24 no longer resisted by a magnetic force.

The magnetic portion 18 contacts a wedge portion 22 of the safety brake 8, 10 via rollers 26. As a result of this contact, the magnetic portion 18 slides the wedge portion 22 along an angled surface of the magnetic portion 18, moving the wedge portion 22 upwards against the biasing of another spring 28 and also towards the guide rail 6a, 6b. This occurs on either side of the guide rail 6a, 6b so that wedge portions 22 on both sides of the guide rail 6a, 6b will contact the guide rail 6a, 6b simultaneously, and symmetrically, to brake on both surfaces of the guide rail 6a, 6b. This type of safety brake 8, 10 is therefore referred to as “symmetrical”. However, it is to be noted that there are different types of safety brakes known to the skilled person. For example, asymmetric safety brakes could be implemented alternatively.

As described above, the elevator system 1 includes the electronic safety actuators 9, 11, which do not have mechanical linkage. Hence, in case one of the safety brakes 8, 10 accidently trips, the other electronic safety actuator, 9, 11 does not automatically actuate the other safety brake 8, 10. The usage of signal processing also does not provide an appropriate solution as there might occur a variation of timing regarding the braking of the other safety brake 8, 10. As a result, there is a risk that the elevator car 2 could derail, i.e. the guide elements could derail from the guide rails 6a, 6b.

FIG. 3 shows an electronic safety actuator system 100 according to an embodiment of the present disclosure. The electronic safety actuator system 100 is implemented into the above described elevator car 2.

The electronic safety actuator system 100 comprises the first electronic safety actuator 9 and the second electronic safety actuator 11. The first electronic safety actuator 11 comprises a first electromagnetic element 30, which corresponds to the electromagnetic element 16 of FIG. 2, for example the coil, and is configured to actuate the first safety brake 8. The first electronic safety actuator 9 also comprises a first actuation detection switch 32, which switches in accordance with an actuation of the first safety brake 8. Likewise, the second electronic safety actuator 11 comprises a second electromagnetic element 34 and a second actuation detection switch 36, which switches in accordance with an actuation of the second safety brake 10.

As shown in FIG. 3, the electromagnetic element 30 and the electromagnetic element 34 are connected to a common power supply circuit 38 in order to be supplied with power from a power supply 40. As described above, whether power is continuously supplied to the electromagnetic elements 30, 34 or only in case of a braking operation depends on the design of the electronic safety actuators and the safety brakes 8, 10, in particular on the choice of the springs 24 between the electromagnetic element 16 and the magnetic portion 18. In the present embodiment, power is continuously supplied to the electromagnetic elements 30, 34 and the supply of electric power is interrupted in case a braking operation is to be performed.

In the present embodiment, the actuation detection switches 32, 36 are connected to the common power supply circuit 38. In particular, the electromagnetic element 30, the actuation detection switch 32, the electromagnetic element 34 and the actuation detection switch 36 are connected in series in the power supply circuit 38 and, thus, with the power supply 40. Since in the present embodiment the safety brakes 8, 10 are designed to brake in case a supply of electric power to the respective electromagnetic element 30, 34 is interrupted, the actuation detection switches 32, 36 are configured to open upon detection of an actuation of the associated safety brake 8, 10. Consequently, no power is supplied to either electromagnetic element 30, 34 upon switching, i.e. opening, of one of the actuation detection switches 32, 36 so that both safety brakes 8, 10 are actuated simultaneously. So an accidental trip of one of the safety brakes 8, 10 causes the respective actuation detection switch 32, 36 to open so that the other safety brake 8, 10 is actuated, too.

In addition, an over-speed contactor 42 is arranged in the power supply circuit 38. The over-speed contactor 42 is configured to operate in accordance with a signal supplied from the electronic over-speed sensor 15. In the present embodiment, the over-speed contactor 42 is configured to open in case over-speed is detected. Hence, the supply of electric power to either electromagnetic elements 30, 34 is reliably interrupted when the over-speed contactor 42 opens.

Further, a resetting line 44, in which a resetting contactor 46 is connected, is arranged in parallel to the electromagnetic elements 30, 34 and the power supply 40. During normal operation, the resetting contactor 45 is open. Upon actuation of the safety brakes 8, 10 due to accidental trip of one of the safety brakes 8, 10, the resetting contactor 46 can be closed to release the safety brakes 8, 10 despite the actuation detection switches 32, 36 being open.

As shown in FIG. 3, the power supply 40, the over-speed contactor 42, and the resetting contactor 46 are arranged on a safety actuator board 48. The safety actuator board 48 can be installed in a control panel of the elevator car 2.

FIG. 4 shows an electronic safety actuator system 100 according to another embodiment of the present disclosure. The electronic safety actuator system 100 comprises the electronic safety actuators 9, 11 having the electromagnetic elements 30, 34, which correspond to the electromagnetic element 16 of FIG. 2, and the actuation detection switches 32, 36, respectively. The electromagnetic elements 30, 34 are connected to the common power supply circuit 38 in order to be supplied with electric power from the power supply 40. In the power supply circuit 38, there is also arranged the over-speed contactor 42, which opens in accordance with an over-speed detection by the electronic over-speed sensor 15. Again, the safety brakes 8, 10 and, thus, the electromagnetic elements 30, 34 are designed to brake in case electric power is not supplied.

In the present embodiment, the actuation detection switches 32, 36 are not connected in the power supply circuit 38 but are inductively coupled to the power supply circuit 38. For this reason, the actuation detection switches 32, 36 are connected to an actuation detection switch circuit 50, in which an auxiliary power supply 52 is connected.

The power supply circuit 38 and the actuation detection switch circuit 50 are inductively coupled by using an inductive coupling unit 54. The inductive coupling unit 54 comprises an inductive coupling coil 56 connected in the actuation detection switch circuit 50 and an inductive coupling coil 58 arranged in the power supply circuit 38. The inductive coupling switch 58 is operated in accordance with electric power supplied to the inductive coupling coil 56. In particular, the inductive coupling switch 58 opens in case electric power is not supplied to the inductive coupling coil 56.

In the present embodiment, the detection actuation switches 32, 36 are configured to open upon detection of actuation of the corresponding safety brake 8, 10. Hence, upon opening of one of the detection actuation switches 32, 36, electric power from the auxiliary power supply 52 is no longer supplied to the inductive coupling coil 56. Therefore, the inductive coupling switch 58 opens so that supply of electric power form the power supply 40 to the electromagnetic elements 30, 34 is interrupted and the safety brakes 8, 10 are actuated. Hence, the safety brakes 8, 10 are operated simultaneously. Hence, an accidental trip of one of the safety brakes 8, 10 causes the actuation of the other safety brake 8, 10 so that derailing of the elevator car 2 can be securely avoided.

As shown in FIG. 4, a resetting line 44, in which a resetting contactor 46 is arranged, is connected in parallel to the auxiliary power supply 52 and the inductive coupling unit 56. When the resetting contactor 46 is closed, the inductive coupling coil 56 is supplied with electric power from the auxiliary power supply 52 so that the inductive coupling switch 58 is closed. In this way, the inductive coupling switch 58 can be closed irrespective of an opening state of the actuation detection switches 32, 36. Hence, the electromagnetic elements 30, 34 can be reset.

As shown in FIG. 4, the power supply 40, the over-speed contactor 42, the inductive coupling unit 54, i.e. the inductive coupling coil 56 and the inductive coupling switch 58, the auxiliary power supply 52, and the resetting contactor 46 are arranged on a safety actuator board 48. The safety actuator board 48 can be installed in a control panel of the elevator car 2.

Consequently, the electronic safety actuator system 100 according to the present disclosure enables the synchronization of the actuation of safety brakes 8, 10 arranged on opposite sides of an elevator car 2 without mechanical linkage and without using signal processing. Therefore, derailing of the elevator car 2 in case of an accidental trip of one of the safety brakes 8, 10 can be reliably avoided.

In the above detailed description of embodiments, an application of the electronic safety actuator system 100 to an elevator car 2 was described. However, the electronic safety actuator system 100 can also be applied to a counterweight 12. In this way, the actuation of safety brakes 8, 10 arranged on opposite sides of the counterweight 12 can be synchronized without mechanical linkage and without using signal processing. Therefore, derailing of the counterweight in case of an accidental trip of one of the safety brakes 8, 10 can be reliably avoided.

What is claimed is:

1. Electronic safety actuator system (100) for an elevator car (2) or a counterweight (12) comprising:
a first electronic safety actuator (9) comprising a first electromagnetic element (16, 30) configured to actuate a first safety brake (8) depending on whether it is supplied with electric power or not, and a first actuation detection switch (32) configured to switch upon actuation of the first safety brake (8);
a second electronic safety actuator (11) comprising a second electromagnetic element (16, 34) configured to actuate a second safety brake (10) depending on whether it is supplied with electric power or not, and a second actuation detection switch (36) configured to switch upon actuation of the second safety brake (10);
wherein the first actuation detection switch (32) is linked to the second electromagnetic element (16, 34) to control a supply of electric power when switching, and the second actuation detection switch (36) is linked to the first electromagnetic element (16, 30) to control a supply of electric power when switching.

2. Electronic safety actuator system (100) according to claim 1, wherein
the first electromagnetic element (16, 30) and the second electromagnetic element (16, 34) are connected to a common power supply (40) via a common power supply circuit (38).

3. Electronic safety actuator system (100), according to claim 2, wherein
the first actuation detection switch (32) and the second actuation detection switch (36) are each linked to the common power supply circuit (38).

4. Electronic safety actuator system (100) according to claim 3, wherein
the first actuation detection switch (32) and the second actuation detection switch (36) are connected in the common power supply circuit (38).

5. Electronic safety actuator system (100) according to claim 4, wherein
a resetting contactor (46) is connected between the first electromagnetic element (16, 30) and the second electromagnetic element (16, 34) via a resetting line (44) and in parallel to the power supply (40) in order to control supply of electric power to the first electromagnetic element (16, 30) and the second electromagnetic element (16, 34) independent of a switching state of the first actuation detection switch (32) and the second actuation detection switch (36).

6. Electronic safety actuator system (100) according to claim 3, wherein
the first actuation detection switch (32) and the second actuation detection switch (36) are inductively coupled to the common power supply circuit (40).

7. Electronic safety actuator system (100) according to claim 6, wherein
the first actuation detection switch (32) and the second actuation detection switch (36) are connected to an actuation detection switch circuit (50) separate from the common power supply circuit (38), and
the electronic safety actuator system (100) further comprises an inductive coupling unit (54) for inductively coupling the actuation detection switch circuit (50) and the common power supply circuit (38).

8. Electronic safety actuator system (100) according to claim 7, wherein
the inductive coupling unit (54) comprises:
an inductive coupling coil (56) arranged in the actuation detection switch circuit (50), and
an inductive coupling switch (58) arranged in the common power supply circuit (38) and operable in accordance with an operation state of the inductive coupling coil (56).

9. Electronic safety actuator system (100) according to claim 7, wherein
an auxiliary power supply (52) is arranged in the actuation detection switch circuit (50).

10. Electronic safety actuator system (100) according to claim 9, wherein
a resetting contactor (46) is connected in parallel to the inductive coupling unit (54) and the auxiliary power supply (52) via a resetting line (44) in order to control supply of electric power to the inductive coupling unit (54) from the auxiliary power supply (52).

11. Electronic safety actuator system (100) according to claim 1, wherein
the power supply (40), the auxiliary power supply (52), the resetting contactor (46), an over-speed contactor (42) and the inductive coupling unit (54) are arranged on a safety actuator board (48).

12. Electronic safety actuator system (100) according to claim 1, wherein
the first electromagnetic element (16, 30) and the second electromagnetic element (16, 34) are configured to actuate the first safety brake (8) and the second safety brake (10), respectively, when electric power is not supplied.

13. Electronic safety actuator system (100) according to claim 1, wherein
the first actuation detection switch (32) and the second actuation detection switch (36) are each configured to open upon actuation of the first safety brake (8) and the second safety brake (10), respectively.

14. Electronic safety actuator system (100) according to claim 5,
wherein the resetting contactor (46) is configured to close in order to operate the first electromagnetic element (16, 30) and the second electromagnetic element (16, 34).

15. Elevator car (2) or counterweight (12) comprising:
the electronic safety actuator system (100) according to claim 1,
the first safety brake (8), and
the second safety brake (10).
